(19) United States
(12) Patent Application Publication
(10) Pub. No.: US 2024/0343563 A1
(43) Pub. Date: Oct. 17, 2024

(54) Methods of Utilizing Captured Carbon Dioxide to Generate Hydrogen for Powering Oilfield Equipment

(71) Applicant: Halliburton Energy Services, Inc., Houston, TX (US)

(72) Inventors: Philip D. NGUYEN, Houston, TX (US); Ronald Glen DUSTERHOFT, Houston, TX (US); Stanley Vernon STEPHENSON, Duncan, OK (US); I Wayan Rakananda SAPUTRA, Houston, TX (US)

(21) Appl. No.: 18/134,935

(22) Filed: Apr. 14, 2023

(51) Int. Cl. C01B 3/08; B01J 8/00; B01J 10/00; B01J 19/24; H01M 8/0612; H01M 16/00

(52) U.S. Cl. CPC C01B 3/08; B01J 8/005; B01J 8/008; B01J 10/00; B01J 19/245; H01M 8/0612; H01M 16/006

(57) ABSTRACT

A system comprising a first reactor, a second reactor fluidly connected with the first reactor, and a liquid-solid separator fluidly connected with the second reactor. The first reactor is operable to produce an aqueous bicarbonate solution from captured carbon dioxide (CO₂), and an aqueous alkaline solution. The second reactor is configured to produce hydrogen gas and a mixture comprising metal carbonate agglomerates by contacting the aqueous bicarbonate solution from the first reactor with zero-valent metal particulates. The metal carbonate agglomerates comprise a carbonate of the metal on a surface of the zero-valent metal particulates, and the zero-valent metal particulates comprise a zero-valent metal. The liquid-solid separator is configured to receive the mixture from the second reactor and separate the metal carbonate agglomerates from a recovered aqueous alkaline solution.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present disclosure relates generally to systems and methods of sequestering carbon dioxide (CO₂). More specifically, this disclosure relates to utilizing at least a portion of a captured CO₂ in a process that produces hydrogen gas that can subsequently be utilized to produce electricity. Still more specifically, this disclosure relates to capturing CO₂, separating high purity CO₂ from the captured CO₂, forming hydrogen gas and metal carbonate aggregates utilizing at least a portion of the high purity CO₂, and optionally utilizing the hydrogen gas to produce electricity, for example via one or more fuel cells, which can be utilized for powering (e.g., oilfield) equipment.

### BACKGROUND

Natural resources (e.g., oil or gas) residing in a subterranean formation can be recovered by driving resources from the formation into a wellbore using, for example, a pressure gradient that exists between the formation and the wellbore, the force of gravity, displacement of the resources from the formation using a pump or the force of another fluid injected into the well or an adjacent well. A number of wellbore servicing fluids can be utilized during the formation and production from such wellbores. For example, in embodiments, the production of fluid in the formation can be increased by hydraulically fracturing the formation. That is, a treatment fluid (e.g., a fracturing fluid) can be pumped down the wellbore to the formation at a rate and a pressure sufficient to form fractures that extend into the formation, providing additional pathways through which the oil or gas can flow to the well. Subsequently, oil or gas residing in the subterranean formation can be recovered or “produced” from the well by driving the fluid into the well. During production of the oil or gas, substantial quantities of produced water, which can contain high levels of total dissolved solids (TDS) can also be produced from the well, and a variety of exhaust gases and flare gases conventionally sent to flare can be formed. For example, oil and gas wells produce oil, gas, and/or byproducts from subterranean formation hydrocarbon reservoirs. A variety of subterranean formation operations are utilized to obtain such hydrocarbons, such as drilling operations, completion operations, stimulation operations, production operations, enhanced recovery operations, and the like. Such subterranean formation operations typically use a large number of vehicles, heavy equipment, and other apparatus (collectively referred to as “machinery” herein) in order to achieve certain job requirements, such as treatment fluid pump rates. Such equipment may include, for example, pump trucks, sand trucks, cranes, conveyance equipment, mixing machinery, and the like. Many of these operations and machinery utilize combustion engines that produce exhaust gases (e.g., including carbon dioxide (CO₂)/greenhouse gas emissions) that can be emitted into the atmosphere. Such operations can also utilize and/or result in the production of water.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic flow diagram of a system, according to embodiments of this disclosure; and

FIG. 2 is a schematic of a plurality of machinery that may be located and operated at a wellsite for performing a subterranean formation operation and may produce exhaust gas comprising CO₂, according to one or more embodiments of the present disclosure;

### DETAILED DESCRIPTION

It should be understood at the outset that although an illustrative implementation of one or more embodiments are provided below, the disclosed systems and/or methods can be implemented using any number of techniques, whether currently known or in existence. The disclosure should in no way be limited to the illustrative implementations, drawings, and techniques below, including the exemplary designs and implementations illustrated and described herein, but can be modified within the scope of the appended claims along with their full scope of equivalents.

Quantities of carbon dioxide (CO₂) are emitted as part of exhaust gas produced during wellbore servicing (e.g., hydraulic fracturing) operations. Decarbonization, which seeks to reduce carbon dioxide emissions through the use of low carbon power sources, is a technical challenge for many industries because decarbonization is not only energy-intensive but also directly emits CO₂ as part of the production process. Capturing CO₂, compressing it to a liquid form, and then transporting it and ultimately injecting it into sites underground for sequestration may provide economical and environmental challenges. Hydrogen (H₂) is a superior fuel for powering fuel cells, but its current cost is quite high. A majority of the hydrogen commercially generated today is created via steam-methane reforming (SMR) and methane pyrolysis processes that utilize high temperatures (e.g., above 900° C.) to convert methane into hydrogen fuel. Electrolysis of water requires large amount of electricity to split water into hydrogen and oxygen. The use of hydrogen to power H₂ fuel cells for generating electricity to power equipment at a wellsite (e.g., hydraulic fracturing equipment) can provide a path to reducing CO₂ emissions.

Carbon dioxide is a product that can be created in industry, for example with oilfield operating equipment, such as hydraulic horsepower pumping units on hydraulic fracturing locations in the field. For example, emissions comprising CO₂ can be created when combusting diesel, methane or a combination of diesel and methane to power equipment. Even when using electricity powered frac pumps, CO₂ can be generated when generating the electricity and utilized herein. Via the system and method of this disclosure, captured CO₂ can utilized be in a process for the production of hydrogen gas which hydrogen gas can subsequently be put to use, for example, to produce electricity (e.g., with no CO₂ emissions). In the process for the production of hydrogen gas, the CO₂ can be converted to metal carbonates. In embodiments, produced water can be utilized in the process for the production of hydrogen. Accordingly, the system and method described herein can, in embodiments, enable sequestering of CO₂ and a reduction of greenhouse gas (e.g., CO₂) emissions, and/or can also reduce an amount of produced water or other “waste” water that needs to be handled/disposed.

Via the system and method of this disclosure, carbon dioxide can be captured, for example, from exhaust gas (e.g., at a wellsite, for example at a hydraulic fracturing location), flue gas (e.g., from power plants, chemical plants, cement plants, refineries, etc.), landfill gas, air, etc., and the captured carbon dioxide can be utilized to produce hydrogen gas, as detailed hereinbelow. The hydrogen gas can be utilized for the production of electricity. For example, in embodiments, the hydrogen gas can be introduced into one or more hydrogen fuel cells and the electricity produced therefrom can be utilized to power electrical equipment and/or to charge batteries for use at a same or different site from that at which the hydrogen gas is produced. This can, in embodiments, enable hybrid crews with both diesel and/or gas powered equipment and electrical equipment, and/or can enable CO₂ captured from electrical generating equipment to be utilized to generate electricity from fuel cells to reduce the amount of fuel consumed and CO₂ created by electrical generators. Alternatively or additionally, all or a portion of the hydrogen can be stored for later use or sale.

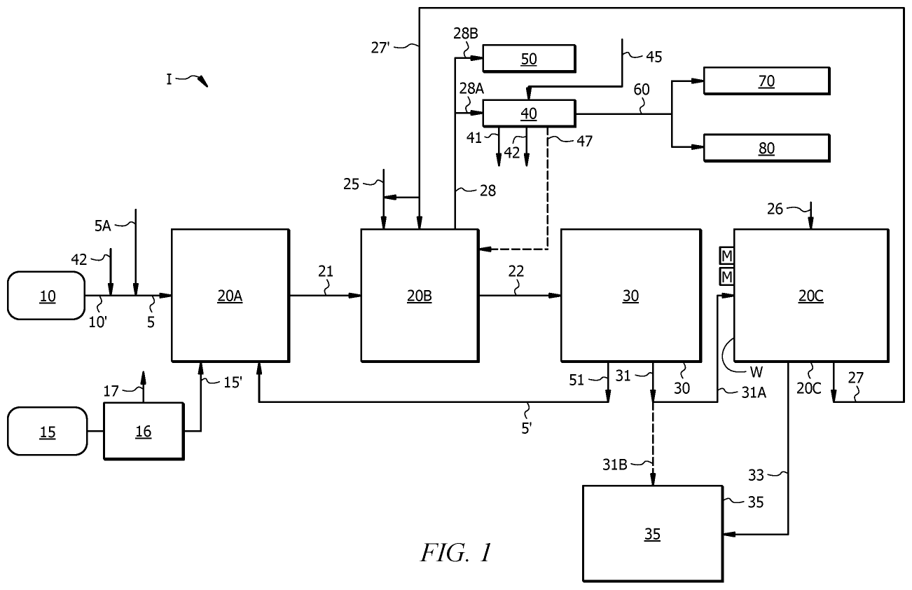

A system and method of this disclosure will now be described with reference to FIG. 1, which is a schematic of a system I according to embodiments of this disclosure. With reference to FIG. 1, system of this disclosure comprises a first reactor 20A, a second reactor 20B, and a liquid-solid separator 30. As depicted in FIG. 1, a system I of this disclosure can further include a water source 10, a captured CO₂ source 15, a CO₂ purification apparatus 16, a third reactor and/or separation device 20C (also referred to herein as a “third reactor/separation device 20C” or simply “third reactor 20C”, a solids storage apparatus 35, a hydrogen storage device 50, one or more hydrogen fuel cells 40, equipment 70 (e.g., oilfield equipment), one or more batteries 80, or a combination thereof. Although depicted in a certain configuration in FIG. 1, in embodiments, one or more components depicted in FIG. 1 can be absent (e.g., a system of this disclosure need not include a solids storage apparatus 35, a hydrogen storage device 50, one or more hydrogen fuel cells 40, equipment 70, one or more batteries 80, or a combination thereof, in embodiments), and/or one or more components can be repeated (e.g., a system of this disclosure can comprise two first reactors 20A) and/or can be arranged in a different order than described hereinbelow or depicted in the embodiment of FIG. 1.

A system of this disclosure comprises a first reactor 20A. First reactor 20A is operable to produce an aqueous bicarbonate solution 21 from captured carbon dioxide (CO₂) 15′, and an aqueous alkaline solution 5 (e.g., comprising concentrated base/alkaline solution 5A and water 10′). For example, when the aqueous alkaline solution comprises sodium hydroxide (NaOH), an aqueous bicarbonate solution comprising aqueous sodium bicarbonate (NaHCO₃ (aq)) can be produced by the reaction according to Equation (1):

$${CO}_{2} ( g ) + NaOH ( aq ) \to {NaHCO}_{3} ( aq ) . \qquad ( 1 )$$

A method of this disclosure can comprise (i) producing an aqueous bicarbonate solution 21 by contacting captured carbon dioxide (CO₂) 15′ with an aqueous alkaline solution 5. The aqueous alkaline solution 5 can be produced by combining a concentrated alkaline solution 5A with water 10′. The concentrated alkaline solution 5A and the water 10′ can be combined to form aqueous alkaline solution 5 prior to being introduced into first reactor 20A, or can be introduced separately into first reactor 20A. In embodiments, the aqueous alkaline solution 5 comprises an alkaline hydroxide solution, such as sodium hydroxide (NaOH), potassium hydroxide (KOH), lithium hydroxide (LiOH), rubidium hydroxide (RbOH), cesium hydroxide (CsOH), francium hydroxide (FrOH), or a combination thereof.

The bicarbonate solution 21 can comprise a high bicarbonate concentration. For example, in embodiments, the bicarbonate solution 21 and/or the contents of second reactor 20B can comprise greater than or equal to about 5, 10, 20, 30, or 40 weight percent (wt %) bicarbonate. In embodiments, the bicarbonate solution 21 and/or the contents of second reactor 20B can comprise greater than or equal to about 5, 10, 20, 30, or 40 weight percent (wt %) sodium bicarbonate.

First reactor 20A can be configured for operation with a pH in a range of from about 7 to about 8.5, from about 7.5 to about 8.5, or from about 7.8 to about 8.2. For example, concentrated alkaline solution 5A and/or a recovered aqueous alkaline solution 5′ recycled from liquid-solid separator 30, as described further hereinbelow, can be introduced into first reactor 20A to maintain a pH therein in the ranges noted above.

In embodiments, the water 10′ comprises fresh water, sea water, produced water, formation water, brine, high-total dissolved solids (TDS) water (e.g., water having a total dissolved solids (TDS) content of greater than or equal to about 10,000 ppm, 50,000 ppm, or 300,000 ppm), or a combination thereof. The water 10′ can be obtained from a water source 10 comprising a fresh water source, a salt water source, a brine source, a sea, a formation (e.g., a geological brine), a production plant of an oil and gas (O&G) operation (e.g., produced water), a water processing facility (e.g., a sea water desalination plant, a brackish water desalination plant, a groundwater recovery facility, a wastewater facility, blowdown water from a cooling tower), or a combination thereof. For example, in embodiments, the water 10′ utilized in the reaction of Eq. (1) can be produced on site at a same location as or close by a site at which the system I is located. For example, in embodiments, a waste water, such as a produced water, can be utilized in first reactor 20A, for example when the system I is located at a wellsite.

In embodiments, the captured CO₂ 15′ utilized in the reaction of Eq. (1) or the like to produce the aqueous bicarbonate solution 21 has a purity of greater than or equal to about 99, 99.5, 99.6, 99.7, 99.8, 99.9, or 100 volume percent (vol %). In embodiments, the captured CO₂ 10′ can be obtained from a CO₂ source 15 comprising a flue gas, an exhaust gas, a produced gas, a landfill gas, the atmosphere, or a combination thereof. In this manner, for example, an exhaust gas, a flue gas, or a produced gas comprising CO₂ and produced at a wellsite can be utilized, in embodiments, in a first reactor 20A located at the or a nearby wellsite. Accordingly, in embodiments, the CO₂ source 15 is produced at a same site at which the system I is located (e.g., a wellsite). As the captured CO₂ source may comprise impurities, a system I of this disclosure can further include a CO₂ purification apparatus (also referred to herein as a “CO₂ separation apparatus”) 16 configured for removing one or more impurities (e.g., water, solids (e.g., soot, dust), oxygen, nitrogen, or a combination thereof) from the CO₂ source 15, such that the captured CO₂ 15′ utilized to produce the soluble, aqueous bicarbonate 21 (e.g., via a reaction of Eq. (1) or the like) has a purity of greater than or equal to about 99, 99.5, 99.6, 99.7, 99.8, 99.9, or 100 volume percent (vol %). The CO₂ purification apparatus 16 can comprise any suitable apparatus, such as, for example, a membrane unit, an amine unit, a carbon fiber filtration unit, or another unit configured to remove the one or more impurities from the captured CO₂ 15′.

The captured CO₂ can comprise CO₂ captured from a variety of locations. For example, in embodiments, the carbon dioxide can be captured from equipment used during an oil or gas operation. Oil and gas operations typically require equipment that produce exhaust gas, which includes carbon dioxide. Carbon dioxide can also be a component of produced gas during oil or gas production operations. The carbon dioxide can also be captured from waste gas (e.g., flue gas, exhaust gas) from other types of equipment besides oil or gas operations, such as heavy industries whose processes can produce carbon dioxide. The carbon dioxide can also be captured from landfills.

The captured CO₂ can be captured into a variety of receptacles, such as pipes, storage tanks, or membranes. In embodiments, the captured CO₂ gas 15′ introduced into the first reactor 20A can be substantially 100% carbon dioxide. Accordingly, one or more impurities, such as other gases or solid particulates, can be separated from the captured CO₂ source 15 to provide the captured CO₂ 15′ introduced into first reactor 20A if the captured fluid of the CO₂ source 15 is not pure carbon dioxide. Accordingly, CO₂ purification apparatus 16 can be utilized to remove one or more impurities 17. CO₂ purification apparatus 16 can comprise one or more membranes through which the captured CO₂ source 15 fluid flows to remove impurities therefrom and provide the captured CO₂ 15′ introduced into first reactor 20A. The membrane can selectively retain impurities, such as other gases or solid particulates, and allow carbon dioxide to pass through the membrane. In this manner, only captured carbon dioxide (e.g., substantially pure) is introduced into the first reactor 20A. Thus, captured CO₂ source 15′ can consist of carbon dioxide gas, in embodiments.

In embodiments, CO₂ source 15 can comprise atmosphere (e.g., air). In such embodiments, a system of this disclosure can further comprise a CO₂ separation/purification apparatus 16 comprising apparatus for absorbing CO₂ from the air to produce a carbonate solution, and causticize and heat the carbonate solution to release the captured CO₂ 15′, such that the captured CO₂ 15′ has a purity of greater than or equal to about 99, 99.5, 99.6, 99.7, 99.8, 99.9, or 100 volume percent (vol %). The captured CO₂ source 15 can comprise CO₂ gas collection apparatus configured to collected CO₂ from an exhaust gas, a landfill gas, a flue gas, the air, a waste gas, or a combination thereof.

In some embodiments, a system I of this disclosure can comprise two or more first reactors 20A in series, and configured for sequential introduction of the captured CO₂ 15′ into the water 10′ (e.g., into aqueous alkaline solution 5) to allow the CO₂ gas to absorb and react with the aqueous alkaline (e.g., NaOH) solution 5 to form soluble aqueous (e.g., sodium) bicarbonate solution 21 at pH, for example, in a range of from about 7 to about 8.5.

A system of this disclosure further comprises a second reactor 20B. Second reactor 20B is fluidly connected with the first reactor 20A and is configured to produce hydrogen gas 28 and a mixture 22 comprising metal carbonate agglomerates 31 by contacting the aqueous bicarbonate solution 21 from the first reactor 20A with zero-valent metal particulates 25. The zero-valent metal particulates 25 comprise a zero-valent metal, such as, for example Fe° or Mg°. The zero-valent metal can comprise magnesium (Mg°), iron (Fe°), aluminum (Al°), zinc (Zn°), nickel (Ni°), titanium (Ti°), or palladium (Pd°). The zero-valent metal particulates 25 can comprise iron powder or magnesium strips. In embodiments, the zero-valent metal particulates 25 (e.g., zero-valent iron or magnesium particulates) are in the form of powder, particulates, scrap fragments, strips, or ribbons, for example, milling waste particulates.

As detailed further herein below, a method of this disclosure can (ii) producing hydrogen gas 28 and a mixture 22 comprising metal carbonate agglomerates 31 by contacting the aqueous bicarbonate solution 21 with zero-valent metal particulates 25, wherein the zero-valent metal particulates 25 comprise a zero-valent metal, and wherein the metal carbonate agglomerates 31 comprise a carbonate of the metal 33 on a surface of the zero-valent metal particulates 25. The metal can also comprise (iii) separating the hydrogen gas 28 from the mixture 22.

The metal carbonate agglomerates 31 comprise a carbonate 33 of the metal (e.g., iron (II) (ferrous) carbonate (FeCO₃) or magnesium carbonate (MgCO₃)) on a surface of the zero-valent metal particulates 25. For example, when the alkaline hydroxide comprises NaOH and the metal comprises iron (Fe°), the hydrogen gas 28 can be produced via the reaction of Equation (2A):

$$Fe ° ( s ) + {NaHCO}_{3} ( aq ) + {H}_{2} O \to {FeCO}_{3} ( s ) + NaOH ( aq ) + {H}_{2} ( g ) . \qquad Eq . ( 2 A )$$

By way of further example, when the alkaline hydroxide comprises NaOH and the metal comprises magnesium (Mg°), the hydrogen gas 28 can be produced via the reaction of Equation (2B):

$$Mg ° ( s ) + {NaHCO}_{3} ( aq ) + {H}_{2} O \to {MgCO}_{3} ( s ) + NaOH ( aq ) + {H}_{2} ( g ) . \qquad Eq . ( 2 B )$$

The captured CO₂ 15′ is thus utilized in reacting with the alkaline solution 5 to form aqueous bicarbonate 21 with which a zero-valent metal 25, such as iron or magnesium particulates, reacts to extract hydrogen gas 28 from bicarbonate and water.

The second reactor 20B can be configured to produce the hydrogen gas 28 and the mixture 22 comprising the metal carbonate agglomerates 31 by contacting the aqueous bicarbonate solution 21 from the first reactor 20A with the zero-valent metal particulates 25 in an anaerobic (e.g., substantially oxygen-free) environment.

Advantageously, in embodiments, the hydrogen gas 28 production is effected at or near room temperature (e.g., at a temperature of less than or equal to about 25, 22, or 20° C.), and/or in the absence of any catalyst.

A system of this disclosure further comprises a liquid-solid separator 30 fluidly connected with the second reactor 20B. The liquid-solid separator 30 is configured to receive the mixture 22 from the second reactor 20B and separate the metal carbonate agglomerates 31A from a recovered aqueous alkaline solution 5′ (e.g., recovered aqueous alkaline hydroxide). In embodiments, the zero-valent metal particulates 25 have a size of less than or equal to about 0.1 μm, 1 μm, 10 μm, 100 μm, or 1 mm in (e.g., average) diameter of powder form, or in a range of from about 0.1 mm to about 1 mm, from about 1 mm to about 5 mm, or from about 2 mm to about 25 mm in (e.g., average) length and in a range of from about 0.01 mm to about 2 mm, from about 0.1 mm to about 2 mm, or from about 0.01 mm to about 1 mm in (e.g., average) width of strip, ribbon, or flake form.

As detailed further hereinbelow, a method of this disclosure can further comprise (iv) separating the metal carbonate agglomerates 31 from the mixture 22 to provide a recovered aqueous alkaline solution 5′, for example comprising recovered aqueous alkaline hydroxide. As depicted in FIG. 1, a system I of this disclosure can further comprise a recycle line fluidly connecting the liquid-solid separator 30 with the first reactor 20A, whereby the recovered aqueous alkaline solution 5′ can be introduced into the first reactor 20A.

A system of this disclosure can further comprise a third reactor and/or separation device 20C configured to receive at least a portion 31A of the metal carbonate agglomerates 31 separated in the liquid-solid separator 30, contact the at least the portion 31A of the metal carbonate agglomerates 31 with a weak acid 26 to remove the carbonate of the metal 33 from the metal carbonate agglomerates 31 and thus provide recovered zero-valent metal particulates 27. The third reactor and/or separation device 20C can be further configured to separate the carbonate of the metal 33 from the recovered zero-valent metal particulates 27. The weak acid can comprise, by way of non-limiting examples, oxalic acid, citric acid, formic acid, acetic acid, benzoic acid, carbonic, trichloroacetic, lactic acid, or a combination thereof.

As detailed further hereinbelow, a method of this disclosure can thus further comprise (v) contacting at least the portion 31A of the metal carbonate agglomerates 31 with a weak acid 26 to remove the carbonate of the metal 33 from the metal carbonate agglomerates 31 and thus provide recovered zero-valent metal particulates 27; and (vi) separating the carbonate of the metal 33 from the recovered zero-valent metal particulates 27.

A system of this disclosure can further comprise a recovered zero-valent metal particulate recycle line 27′ fluidly connecting the third reactor and/or separation device 20C with the second reactor 20B, whereby the recovered zero-valent metal particulates 27 can be recycled to the second reactor 20B for re-use in the production of additional hydrogen gas 28, for example, via the reaction of Eq. (2A) or Eq. (2B), or the like. Third reactor and/or separation device 20C can comprise a separation device configured to separate the carbonate of the metal 33 from the recovered zero-valent metal particulates 27 that is disparate from a third reactor configured to contact the at least the portion of the metal carbonate agglomerates 31A with a weak acid 26 to remove the carbonate of the metal 33 from the metal carbonate agglomerates 31 and thus provide recovered zero-valent metal particulates 27, or a single third reactor and/or separation device 20C can provide both the contacting of the at least the portion 31A of the metal carbonate agglomerates 31A with the weak acid 26 to remove the carbonate of the metal 33 from the metal carbonate agglomerates 31 and thus provide the recovered zero-valent metal particulates 27 and the separating of the carbonate of the metal 33 from the recovered zero-valent metal particulates 27. For example, in embodiments wherein the separation device and the third reactor comprise the same apparatus, the separation device can comprise one or more magnets M positioned on a wall W (e.g., an outside wall) of the third reactor 20C. In embodiments in which the third reactor and the separation device of third reactor and/or separation device 20C are disparate apparatus, the separation device can comprise the one or more magnets M positioned on a wall W (e.g., an outside wall) of the disparate separation device. Magnets M can thus be utilized to produce one or more magnetic fields to enhance the separation of the zero-valent, magnetic metal particulates 25/27 (e.g., Fe° or Mg°) from other slightly magnetic solids, such as metal carbonates 33 (e.g., FeCO₃ or MgCO₃).

A system of this disclosure can further comprise solids storage apparatus 35 connected with the liquid-separator 30, the third reactor and/or separation device 20C, or both, whereby at least a portion 31B of the metal carbonate aggregates 31 from the liquid-solid separator 30, at least a portion of the metal carbonate solids 33 from the third reactor and/or separation device 20C, or a combination thereof can be stored in the solids storage apparatus 35.

A system I of this disclosure can further comprise one or more fuel cells 40 operable to produce electricity 60 from at least a portion 28A of the hydrogen gas 28 produced in the second reactor 20B. The one or more fuel cells 40 can produce heat 41 and water 42 as by-products. In embodiments, the heat 41 and/or the water 42 can be put to use at the site wherein system I is located. For example, in embodiments, the water 42 produced in the one or more fuel cells 40 can be utilized as or in combination with water 10′ to provide aqueous alkaline solution 5 within or upstream of first reactor 20A.

In embodiments, the one or more fuel cells 40 utilize air 45 as a source of oxygen, and thus produce an oxygen-depleted air stream 47 comprising primarily nitrogen. In embodiments, the second reactor 20B can be configured for introduction thereto of at least a portion of the oxygen-depleted air stream 47, whereby the at least the portion of the oxygen-depleted air stream 47 can be introduced into the second reactor 20B to provide an anaerobic environment therein (e.g., to purge oxygen from the second reactor 20B prior to introduction thereto of the zero-valent metal particulates 25/27).

The one or more fuel cells 40 can be located at a same site (e.g., a wellsite) at which the system (e.g., first reactor 20A, the second reactor 20B, and/or the liquid-solid separator 30) are located.

System I of this disclosure can further comprise one or more pieces of equipment (e.g., oilfield equipment) 70. The one or more pieces of equipment 70 are powered at least in part by the electricity 60 produced in the one or more fuel cells 40 from the at least the portion 28A of the hydrogen gas 28 produced in the second reactor 20B. In embodiments, a hybrid fleet can be created with combustion engines that generate CO₂ and electric engines that consume the electricity 60 generated from the one or more hydrogen fuel cells 40.

The system I of this disclosure can further comprise one or more batteries 80 that can be charged at least in part by the electricity 60 produced in the one or more fuel cells 40 from the at least the portion 28A of the hydrogen gas 28 produced in the second reactor 20B.

A system I of this disclosure can further comprise hydrogen storage apparatus 50 configured for storing at least a portion 28B of the hydrogen gas 28 produced in the second reactor 20B. The hydrogen storage apparatus 50 can be configured for storing the at least the portion 28B of the hydrogen gas 28 produced in the second reactor 20B in a gaseous or liquid state.

As noted herein, also disclosed herein is a method comprising: (i) producing an aqueous bicarbonate solution 21 by contacting captured carbon dioxide (CO₂) 15′ with an aqueous alkaline solution 5; (ii) producing hydrogen gas 28 and a mixture 22 comprising metal carbonate agglomerates 31 by contacting the aqueous bicarbonate solution 21 with zero-valent metal particulates 25, wherein the zero-valent metal particulates 25 comprise a zero-valent metal, and wherein the metal carbonate agglomerates 31 comprise a carbonate of the metal 33 on a surface of the zero-valent metal particulates 25; (iii) separating the hydrogen gas 28 from the mixture 22; and (iv) separating the metal carbonate agglomerates 31 from the mixture 22 to provide a recovered aqueous alkaline solution 5′. As noted hereinabove, the zero-valent metal can comprise magnesium (Mg°) or iron (Fe°). In embodiments, the zero-valent metal particulates 25 comprise iron powder or magnesium strips.

Producing an aqueous bicarbonate solution 21 by contacting captured carbon dioxide (CO₂) 15′ with an aqueous alkaline solution 5 at (i) can comprise producing the aqueous bicarbonate solution 21 as described hereinabove with regard to first reactor 20A. For example, producing the aqueous bicarbonate solution 21 at (i) can comprise introducing captured CO₂ 15′ into a first reactor 20A containing water 10′ while the contents of the first reactor 20A are stirred/mixed, introducing an alkaline solution 5 (and/or concentrated alkaline solution 5A) into the first reactor 20A to increase the pH of the CO₂-mixed water within first reactor 20A to a pH as noted above (e.g., a pH between 7 and 8.5), thus forming soluble bicarbonate solution 21 (e.g., sodium bicarbonate solution, when the alkaline solution comprises sodium hydroxide). For example, the method of this disclosure can comprise maintaining a pH during (i) in a range of from about 7 to about 8.5, from about 7.5 to about 8.5, or from about 7.8 to about 8.2 at (i) via the alkaline solution 5 (which can comprise concentrated alkaline solution 5A, recycled recovered aqueous alkaline solution 5′, or a combination thereof).

As noted hereinabove, the alkaline solution 5 (produced external to or within first reactor 20A) can comprise water 10′ and a base (e.g., concentrated alkaline solution 5A), such as, for example, sodium hydroxide, potassium hydroxide (KOH), lithium hydroxide (LiOH), rubidium hydroxide (RbOH), cesium hydroxide (CsOH), francium hydroxide (FrOH), or a combination thereof.

The method can further comprise providing a source 10 of water 10′ or obtaining or producing the water 10′. For example, the method can include producing a produced water, a formation water, a waste water, a high TDS water, or the like on a same site as or a different site from the site at which (i), (ii), (iii), and/or (iv) are performed. As noted above, in embodiments, the water 10′ comprises fresh water, sea water, produced water, formation water, brine, high-total dissolved solids (TDS) water (e.g., water having a total dissolved solids (TDS) content of greater than or equal to about 10,000 ppm, 50.000 ppm, or 300,000 ppm), or a combination thereof. The method of this disclosure can further comprise obtaining the water 10′ from a water source 10 comprising a fresh water source, a brine source, a sea, a formation, a production plant of an oil and gas (O&G) operation, a water processing facility (e.g., a sea water desalination plant, a brackish water desalination plant, a groundwater recovery facility, a wastewater facility, blowdown water from a cooling tower), or a combination thereof.

The method can further comprise providing a source 15 of captured CO₂. The method can further comprise obtaining or capturing the captured CO₂ 15′. For example, the CO₂ source 15 can comprise exhaust gas, such as that produced by oilfield or other equipment, flue gas produced, for example, from power plants and/or cement plants, or CO₂ captured directly from the air. For example, the method can include producing or capturing an exhaust gas, a flue gas, a landfill gas, a produced gas, or the like on a same site as or a different site from the site at which (i), (ii), (iii), and/or (iv) are performed. The method can further include removing one or more impurities from captured CO₂ source 15 to provide captured CO₂ 15′ for reacting according to Eq. (1) or the like to produce aqueous bicarbonate solution 21.

In embodiments, the captured CO₂ 15′ has a purity of greater than or equal to about 99, 99.5, 99.6, 99.7, 99.8, 99.9, or 100 volume percent (vol %). The captured CO₂ 15′ can be obtained from a CO₂ source 15 comprising a flue gas, an exhaust gas, a produced gas, a landfill gas, the atmosphere, or a combination thereof. A method of this disclosure can comprise producing the CO₂ source 15′ at a same site at which (i), (ii), (iii), and/or (iv) are performed, or at a different site. The method of this disclosure can include removing one or more impurities 17 from the CO₂ source 15 to provide the captured CO₂ 15′, such that the captured CO₂ 15′ has a purity of greater than or equal to about 99, 99.5, 99.6, 99.7, 99.8, 99.9, or 100 volume percent (vol %). Removing the one or more impurities 17 from the CO₂ source 15 can comprise passing the CO₂ source through a membrane, or another CO₂ purification device 16, as described further herein.

In embodiments, the CO₂ source 15 comprises atmosphere (e.g., air), and the method further comprises absorbing CO₂ from the air by exposing air containing CO₂ to a basic solution which absorbs CO₂ to produce a carbonate solution, and causticizing and heating the carbonate solution to release the captured CO₂ 15′, wherein the captured CO₂ 15′ has a purity of greater than or equal to about 99, 99.5, 99.6, 99.7, 99.8, 99.9, or 100 volume percent (vol %).

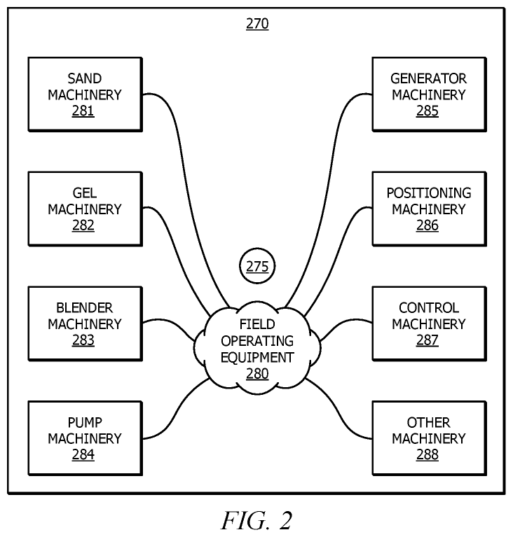

In embodiments, the captured CO₂ source 15 comprises an exhaust gas produced at a wellsite 270. As depicted in FIG. 2, which is a schematic of a plurality of machinery 280 from which an exhaust gas can be produced, the machinery 280 may be located and operated a wellsite 270 for performing a subterranean formation operation and may produce exhaust gas (e.g., which provides captured CO₂ source 15) comprising captured CO₂ 15′, according to one or more embodiments of the present disclosure. The machinery from which the exhaust gas comprising CO₂ can be produced, in embodiments, can include sand machinery 281, gel machinery 282, blender machinery 283, pump machinery 284, generator machinery 285, positioning machinery 286, control machinery 287, and/or other machinery 288. The machinery may be, for example, truck, skid or rig-mounted, or otherwise present at the wellsite 270, without departing from the scope of the present disclosure. The sand machinery 281 may include transport trucks or other vehicles for hauling to and storing at the wellsite 270 sand for use in an operation. The gel machinery 282 may include transport trucks or other vehicles for hauling to and storing at the wellsite 270 materials used to make a gelled treatment fluid for use in an operation. The blender machinery 283 may include blenders, or mixers, for blending materials at the wellsite 270 for an operation. The pump machinery 284 may include pump trucks or other vehicles or conveyance equipment for pumping materials down the wellbore 275 for an operation. The generator machinery 285 may include generator trucks or other vehicles or equipment for generating electric power at the wellsite 270 for an operation. The electric power may be used by sensors, control machinery, and/or other machinery. The positioning equipment 286 may include earth movers, cranes, rigs or other equipment to move, locate or position equipment or materials at the wellsite 270 or in the wellbore 275.

The control machinery 287 may include an instrument truck coupled to some, all, or substantially all of the other equipment at the wellsite 270 and/or to remote systems or equipment. The control machinery 287 may be connected by wireline or wirelessly to other equipment to receive data for or during an operation. The data may be received in real-time or otherwise. In another embodiment, data from or for equipment may be keyed into the control machinery.

The control machinery 287 may include a computer system for planning, monitoring, performing or analyzing the job. Such a computer system may be part of a distributed computing system with data sensed, collected, stored, processed and used from, at or by different equipment or locations. The other machinery 288 may include equipment also used at the wellsite 270 to perform an operation.

In other examples, the other machinery 288 may include personal or other vehicles used to transport workers to the wellsite 270 but not directly used at the wellsite 270 for performing an operation.

Many if not most of these various machinery at the wellsite 270 accordingly utilize a diesel or other fuel types to perform their functionality. Such fuel is expended and exhausted as exhaust gas, such as exhaust gas including CO₂. The embodiments described herein provide a system and method for capturing and converting to bicarbonate and subsequently to carbonate and thus sequestering CO₂ captured from such machinery 280 located and operated at a wellsite 270, and potentially reducing atmospheric CO₂ emissions, while reducing material and time costs, and producing hydrogen gas from which electricity 60 can be produced and utilized to advantage. It is to be appreciated that other configurations of the wellsite 270 may be employed, without departing from the scope of the present disclosure. Although a number of various machinery 280 at wellsite 270 have been mentioned, many other machinery may utilize diesel or other fuel that creates exhaust gas including CO₂ that may conventionally be exhausted into the atmosphere, but herein utilized during the production of hydrogen gas, as described herein.

In some embodiments, the present disclosure provides collecting exhaust gas (e.g., as captured CO₂ source 15 and/or captured CO₂ 15′) from which captured CO₂ 15′ is obtained from such machinery 280 located and operated at a wellsite 270 and utilizing (e.g., purified, as needed) CO₂ from such collected exhaust gas 215 during the formation of hydrogen gas 28 as detailed herein. In embodiments, the exhaust gas is produced by fracturing equipment (e.g., hydraulic fracturing pumping equipment 284, hydraulic horsepower pumping units 284, electrical generation natural gas turbine units 288, electrical generation reciprocating natural gas power units 285, or a combination thereof) utilized to fracture a formation during a fracturing operation in formation 277.

Although described hereinabove with reference to a wellsite 270, a source of the exhaust gas comprising CO₂ can be any convenient exhaust gas. The captured CO₂ source 15 can be a gaseous CO₂ source. This gaseous CO₂ source may vary widely, ranging from air, industrial waste streams, etc. As noted above, the CO₂ source 15 can, in certain instances, include an exhaust waste product from an industrial plant. The nature of the industrial plant may vary in these embodiments, where industrial plants of interest include power plants, chemical processing plants, and other industrial plants that produce flue or exhaust gas comprising CO₂ as a byproduct. By waste stream is meant a stream of gas (or analogous stream) that is produced as a byproduct of an active process of the industrial plant, e.g., an exhaust gas or flue gas. The gaseous stream may be substantially pure CO₂ or a multi-component gaseous stream that includes CO₂ and one or more additional gases. Multi-component gaseous streams (containing CO₂) that may be employed as a captured CO₂ source 15 in embodiments of the subject methods include both reducing, e.g., syngas, shifted syngas, natural gas, and hydrogen and the like, and oxidizing condition streams, e.g., flue gases from combustion. Particular multi-component gaseous streams of interest that may be treated according to the subject invention include: oxygen containing combustion power plant flue gas, turbo charged boiler product gas, coal gasification product gas, shifted coal gasification product gas, anaerobic digester product gas, wellhead natural gas stream, reformed natural gas or methane hydrates, and the like.

The captured CO₂ source 15 can comprise greater than or equal to about 5, 6, 7, 8, 9, 10, 15, 20, 25, 30, 40, 50, 60, 70, 80, 90, 95, 96, 97, 98, 99, or 100 volume percent (vol %) CO₂. In embodiments, the captured CO₂ source 15 includes primarily CO₂ (e.g., greater than or equal to about 50, 60, 70, 80, 90, 95, 96, 97, 98, 99, or 100 volume percent (vol %) CO₂). For example, when an exhaust gas comprising CO₂ is obtained from a waste gas produced at a different jobsite than the wellsite 270, CO₂ can be separated from the waste gas in order to reduce a volume of gas to be transported to the wellsite 270. For example, when the exhaust gas includes a flue gas from a power plant, which typically contains from about 7 to about 10 vol. % CO₂, the method can further include transporting the exhaust gas (or a waste gas from which the captured CO₂ 15′ is obtained) from the another jobsite at which the waste gas is obtained to the wellsite 270. In embodiments, the method can further include separating captured CO₂ source 15/captured CO₂ 15′ from a waste gas including CO₂, prior to transport to wellsite 270, to reduce a volume of gas for transport. Although the separating of the CO₂ from the exhaust gas comprising CO₂ can be performed at the wellsite 270 (e.g., after transport of the waste gas from the another jobsite at which the waste gas is obtained and/or produced to the wellsite 270), to facilitate transportation, the separating of the CO₂ from the exhaust gas comprising CO₂ can be performed at the another jobsite at which the waste gas is produced and/or obtained and subsequently, the captured CO₂ 15′ can be transported to the wellsite 270. Accordingly, CO₂ separation apparatus 16 can be located at a jobsite different from a site at which the hydrogen gas 28 is produced (e.g., wellsite 270) or can be located at a same site (e.g., wellsite 270).

As noted above, a method of this disclosure can comprise separating impurities from the captured CO₂ source 15. Separating impurities from the captured CO₂ source 15 can comprise separating impurities from captured CO₂ source 15 to provide a captured CO₂ 15′ comprising substantially pure CO₂. That is, in embodiments, the captured CO₂ 15′ introduced into first reactor 20A is substantially pure CO₂. The substantially pure CO₂ (and the substantially pure captured CO₂ 15′ introduced into first reactor 20A) can include greater than or equal to about 90, 95, 96, 97, 98, 99, 99.5, 99.8, 99.9, or 100 vol % CO₂. Separating impurities from the captured CO₂ source 15 can comprise passing the captured CO₂ source 15 through a CO₂ separation or purification unit or apparatus 16. CO₂ purification apparatus 16 can comprise any apparatus operable to provide high purity (e.g., greater than or equal to 95, 96, 97, 98, 98.5, 99, 99.5, 99.9, 99.99, or substantially 100 volume percent (vol %) CO₂ from the captured CO₂ source 15. CO₂ separation apparatus 16 can operate by separating via amine absorption, calcium oxide (CaO) absorption, filtration, packed bed, another technique, or a combination thereof. In embodiments, CO₂ separation apparatus 16 comprises a membrane unit, an amine unit, a carbon fiber filtration unit, a reaction bed unit, a venturi reactor, batch reactor, continuous reactor, fluidized pack column, another unit configured to remove one or more impurities from the captured CO₂ source 15. In embodiments, the captured CO₂ 15′ utilized to produce aqueous bicarbonate solution 21 in first reactor 20A comprises from about 10 to about 90, from about 20 to about 80, from about 30 to about 70, from about 40 to about 60, from about 10 to about 50, from about 50 to about 90, or greater than or equal to about 10, 20, 30, 40, 50, 60, 70, 80, or 90 volume percent (vol %) of the CO₂ in the captured CO₂ source 15.

CO₂ purification device 16 can separate solids (e.g., ash, soot, dust) from the captured CO₂ source 15 to provide captured CO₂ 15′ for introduction into first reactor 20A. Separating of the solids can be effected in a solids removal apparatus configured to remove solids from a gas. Such gas/solids removal equipment can comprise, for example, a cyclone, a dust filtration unit, a venturi scrubber, carbon fiber filtration unit a bag filtration unit, or a combination thereof.

Producing hydrogen gas 28 and the mixture 22 comprising metal carbonate agglomerates 31 by contacting the aqueous bicarbonate solution 5 with zero-valent metal particulates 25 at (ii) can be effected as described hereinabove with regard to second reactor 20B. For example, the soluble, aqueous bicarbonate solution 21 can be transferred to second reactor 20B, the second reactor 20B can be purged with inert gas (e.g., nitrogen and/or CO₂ gas) to remove oxygen from the second reactor 20B, zero-valent metal solids 25, such as Fe particulates or Mg strips, can then be introduced into second reactor 20B to react with the soluble, aqueous bicarbonate and produce the hydrogen gas 28, and the mixture 22 comprising aqueous alkaline solution and the metal carbonate aggregate solids 31 having the metal carbonate 33 (e.g., FeCO₃ or MgCO₃) on the outer surface of the zero-valent metal particulates 25.

The second reactor 20B can be stirred/mixed during the reaction (e.g., reaction of Eq. (2A), Eq. (2B), or the like). At (ii), the aqueous bicarbonate solution 21 can be contacted with the zero-valent metal particulates 25 in an anaerobic environment. For example, as noted hereinabove, the second reactor 20B can be purged with oxygen-depleted air (e.g., comprising primarily nitrogen) 47 produced as a byproduct of the use of air to provide oxygen to one or more fuel cells 40, can be purged with nitrogen, can be purged with CO₂ (e.g., a portion of the captured CO₂ source 15 or the captured CO₂ 15′, or with another available inert gas. In such embodiments, a method of this disclosure can include utilizing air 45 as a source of oxygen for one or more fuel cells 40 configured to produce the electricity 60 from the at least the portion 28A of the hydrogen gas 28 produced at (ii), and thus producing an oxygen-depleted air stream 47 comprising primarily nitrogen, and utilizing at least a portion of the oxygen-depleted air stream 47 at (ii), to provide an anaerobic environment for the contacting of the aqueous bicarbonate solution 21 with the zero-valent metal particulates 25. The second reactor 20B containing aqueous (e.g., sodium) bicarbonate solution 21 can be depleted of oxygen by purging the second reactor 20B with nitrogen (or CO₂) gas before introduction thereto of zero-valent metal solids 25, such as iron powder particulates, or magnesium strips, such that oxygen does not interfere with the hydrogen production reaction (e.g., the reaction of Eq. (2A), Eq. (2B), or the like).

As noted hereinabove, a method of this disclosure can further include, at (iii), separating the hydrogen gas 28 from the mixture 22. As described further herein, the method can include collecting and transferring the produced hydrogen 28 to one or more H₂ fuel cells 40 or hydrogen storage apparatus 50. The one or more H₂ fuel cells 50 can be utilized, in embodiments, to generate electricity 60 for powering (e.g., oilfield) equipment 70, and/or for charging batteries 80. Some or all of the hydrogen 28 produced in second reactor 20B can be stored, for example in hydrogen storage apparatus 50.

As noted hereinabove, a method of this disclosure can further include, at (iv) separating the metal carbonate agglomerates 31 from the mixture 22 to provide a recovered aqueous alkaline solution 5′ (e.g., recovered aqueous alkaline hydroxide solution). Accordingly in embodiments, the mixture 22 comprising aggregate solids of iron (or magnesium) carbonate on the outer surfaces of the zero-valent metal particulates 25 and aqueous alkaline solution can be transferred from the second reactor 20B to liquid-solids separator 30 for separating iron (or magnesium) carbonate containing solids (e.g., the metal carbonate agglomerates 31) from recovered aqueous alkaline solution 5′. The recovered aqueous alkaline solution (e.g., aqueous NaOH) 5′ can be recycled back to the first reactor 20A for reuse.

In embodiments, a method of this disclosure can further comprise (v) contacting at least a portion 31A of the metal carbonate agglomerates 31 with a weak acid 26 to remove the carbonate of the metal 33 from (e.g., the surface of) the metal carbonate agglomerates 31 and thus provide recovered zero-valent metal particulates 27; and (vi) separating the carbonate of the metal 33 from the recovered zero-valent metal particulates 27. Accordingly, in embodiments, the separated iron (or magnesium) carbonate aggregate solids 31 (or a portion 31A thereof) can be transferred from liquid-solid separator 20 to a third reactor (which can, in embodiments, also act as a separator, and is thus referred to herein as a “third reactor and/or separation device 20C”) 20C containing a weak acid 26 (e.g., citric or oxalic acid). Upon contact, the weak acid 26 removes metal carbonate 33 (e.g., iron or magnesium carbonate 33) from the surface of zero-valent metal (e.g., Fe° or Mg°) particulates 25, thereby allowing the recovered zero-valent metal particulates 27 to be recycled back to (ii) (e.g., to the second reactor 20B) for producing additional hydrogen gas 28 (e.g., via reaction as shown in Eq. (2A), Eq. (2B), or the like).

As mentioned hereinabove, the contacting of the at least the portion 31A of the metal carbonate agglomerates 31 with the weak acid 26 at (v) and the separating of the carbonate of the metal 33 from the recovered zero-valent metal particulates 27 at (vi) can be performed in a same apparatus, or in disparate apparatus. In embodiments, separating of the carbonate of the metal 33 from the recovered zero-valent metal particulates 27 comprises attracting and separating the zero-valent metal particulate 25/27 from the carbonate of the metal 33 via one or more magnets M.

The method of this disclosure can further comprise storing (e.g., in solids storage apparatus 35) at least a portion 31B of the metal carbonate aggregates 31 separated from the mixture 22 at (iv), at least a portion of the carbonate of the metal 33 separated from the recovered zero-valent metal particles 27 at (vi), or a combination thereof.

The method of this disclosure can further comprise producing electricity 60 (e.g., via or more fuel cells 40) from at least a portion 28A of the hydrogen gas 28 produced at (ii). The hydrogen gas 28 produced in second reactor 20B can thus be introduced, in whole or in part, into the one or more H₂ fuel cells 40 to produce electricity 60. The electricity 60 can be utilized, for example, to power equipment 70 (e.g., oilfield equipment, such as, without limitation, hydraulic fracturing equipment); to charge one or more batteries 80; can be stored, for example, in hydrogen storage apparatus 50, for later usage; or a combination thereof. Accordingly, in embodiments, a method of this disclosure comprises storing at least a portion 28B of the hydrogen gas 28 produced at (ii). The at least the portion 28B of the hydrogen gas 28 produced at (ii) that is stored can be stored in a gaseous and/or liquid state. In embodiments, a method of this disclosure thus comprises powering one or more pieces of equipment 70 at least in part by and/or charging one or more batteries 80 at least in part by the electricity 60 produced from at least a portion 28A of the hydrogen gas 28 produced at (ii). As noted hereinabove, the electricity 60 produced (e.g., via one or more fuel cells 40) from the at least the portion 28A of the hydrogen gas 28 produced at (ii) can be produced a same site (e.g., a wellsite) at which (i), (ii), (iii), and/or (iv) are performed.

In embodiments, a method of this disclosure comprises: producing hydrogen gas 28 and a mixture 22 comprising metal carbonate agglomerates 31 by contacting an aqueous bicarbonate solution 21 with zero-valent metal particulates 25, wherein the zero-valent metal particulates 25 comprise a zero-valent metal, wherein the metal carbonate agglomerates 31 comprise a carbonate of the metal 33 disposed on a surface of the zero-valent metal particulates 25, wherein the aqueous bicarbonate solution 21 comprises water 10′ and a bicarbonate, and wherein the bicarbonate comprises carbon from captured carbon dioxide (CO₂) 15′ captured from a CO₂ source 15, such as a flue gas, an exhaust gas (e.g., produced via equipment 70, such as fracturing equipment (e.g., hydraulic fracturing pumping equipment, hydraulic horsepower pumping units, electrical generation natural gas turbine units, electrical generation reciprocating natural gas power units or a combination thereof)), a produced gas, a landfill gas, air, or a combination thereof. The method can further comprise utilizing at least a portion 28A of the hydrogen gas 28 to produce electricity 60. In embodiments, the captured CO₂ 15′ is produced at a same site at which the method is performed, the water 10′ in the aqueous bicarbonate solution 21 is produced or obtained at the same site at which the method is performed, the electricity 60 produced from the at least the portion 28A of the hydrogen gas 28 is produced at the same site at which the method is performed, or a combination thereof. For example, in embodiments, the captured CO₂ 15′ is produced at a same site at which the method is performed, the water 10′ in the aqueous bicarbonate solution 21 is produced or obtained at the same site at which the method is performed, or a combination thereof. The water 10′ of the aqueous bicarbonate solution 21 can comprise a water as described hereinabove, for example, fresh water, sea water, produced water, formation water, brine, high-total dissolved solids (TDS) water, or a combination thereof. The water can be obtained from a water source 10, as described herein, for example, a water source 10 comprising a fresh water source, a brine source, a sea, a formation, a water produced from oil and/or gas producing well(s), a production plant of an oil and gas (O&G) operation, a water processing facility (e.g., a sea water desalination plant, a brackish water desalination plant, a groundwater recovery facility, a wastewater facility, blowdown water from a cooling tower), or a combination thereof.

The producing of the hydrogen gas 28 via a system and method of this disclosure can be performed substantially continuously or intermittently.

In embodiments, a system of this disclosure, or one or more components thereof (e.g., a gas collection apparatus of captured CO₂ source 15, CO₂ purification apparatus 16, first reactor 20A, second reactor 20B, liquid-solid separator 30, third reactor and/or separation device 20C, or a combination thereof) can be provided on a skid (e.g., a trailer skid), whereby at least a portion the captured CO₂ 15′ can be utilized to produce hydrogen gas 28 at a wellsite 270. In embodiments, the system of this disclosure, or one or more components thereof is provided as a small-scale hydrogen gas 28 production plant (e.g., on one or more skids) at a wellsite 270, whereby hydrogen gas 28 can be produced on location, optionally a same location as that at which the water 10′ is produced/obtained, the captured CO₂ is produced/obtained/purified, and/or electricity 60 is produced and/or utilized.

In embodiments, captured CO₂ source 15 is collected on location at a wellsite 270, impurities 17 are separated from the collected captured CO₂ source 15 on location to provide captured CO₂ 15′, the captured CO₂ 15′ is introduced into a first reactor 20A on location (e.g., at wellsite 270) configured for production of aqueous bicarbonate solution 21, the aqueous bicarbonate solution 21 is utilized to produce hydrogen gas 28 at the wellsite 270, and the hydrogen gas 28 is utilized on location to produce electricity 60, which can also be utilized on site to power equipment 70 and/or to charge one or more batteries 80. The captured CO₂ source 15 can comprise an exhaust gas produced by equipment/machinery 280 utilized during a wellbore operation (e.g., hydraulic fracturing operation, stimulation treatment), as described hereinabove with regard to FIG. 2, in embodiments.

Via the system and method of this disclosure, hydrogen can be produced from a process involving sequestration of captured CO₂ 15′ (e.g., from an exhaust or flue gas source 15) and reaction with an alkaline solution 21 prepared with water 10′ (e.g., high TDS water), which can be produced from a subterranean formation. The process involves introducing the captured CO₂ 15′ into a first reactor 20A containing water 10′ (e.g., fresh or produced water), wherein an aqueous alkaline solution 5 (e.g., of sodium hydroxide) is introduced into the first reactor 20A under stirring/agitation to raise the pH of the water 10′ to a pH between 7 and 8.5 for enhancing formation of soluble sodium bicarbonate 21 (e.g., as per Eq. (1) or the like). The first reactor 20A or a second reactor 20B into which the (e.g., sodium) bicarbonate solution 21 has been transferred is then depleted of oxygen as solid particulates of zero-valent metals 25, such as iron powder, or strips of magnesium, are added to the reactor to react with the aqueous bicarbonate solution 21 for producing hydrogen gas 28, and metal (e.g., iron or magnesium) carbonate aggregate solids 31 in aqueous alkaline solution (e.g., aqueous sodium hydroxide) (e.g., as per Eq. (2A), Eq. (2B), or the like). The produced hydrogen gas 28 can be introduced into one or more H₂ fuel cells 40 to generate electricity 60 for powering (e.g., wellsite) equipment 70 and/or for charging one or more batteries 80. Within the second reactor 20B, solid metal carbonate is formed on the outer surface of zero-valent metal 25 (e.g., iron (Fe°) or magnesium (Mg°) solids to form the metal carbonate aggregates 31. The produced metal carbonate solids 33 can be removed from the metal carbonate aggregates 31 by reacting with a weak acid 26, thus allowing recovered zero-valent metal particulates 27 (e.g., the zero-valent iron or magnesium solids) to be recycled. The removed metal carbonate 33 (e.g., iron or magnesium carbonate solids 33) can be utilized, in embodiments, as raw materials in, for example, cement or steel making processes. Furthermore, the recovered aqueous alkaline solution 5′ (e.g., recovered aqueous NaOH solution) separated from the metal carbonate aggregates 31 in liquid-solid separator 30 can be recycled back to the first reactor 20A containing the captured CO₂ 15′ and the (e.g., produced) water 10′ to increase the pH for producing additional soluble (e.g., sodium) bicarbonate 21.

Unlike steam methane reforming, and other current well-known H₂ generating processes, that typically produce large amount of CO₂ as a result of burning methane or coal for generating the requisite high-temperature steam, the system and method of this disclosure provide for converting captured CO₂ 15′ into hydrogen gas 28 by absorbing the captured CO₂ 15′ in an alkaline solution 5 and reacting the formed soluble bicarbonates 21 with a zero-valent metal 25, such as iron or magnesium solid particulates, in an anaerobic reaction at room temperature. The process provides a high conversion efficiency, e.g., greater than or equal to about 95, 96, 97, or 98%, even without catalyst. The reaction that produces the hydrogen gas (e.g., the reaction of Eq. (2A), Eq. (2B), or the like) occurs at room temperature, and thus, no external energy may be needed. The reaction that produces the hydrogen gas (e.g., the reaction of Eq. (2A), Eq. (2B), or the like) requires no catalyst, and provides a high reaction rate for hydrogen gas 28 production with high bicarbonate concentration (e.g., concentration of bicarbonate, such as sodium bicarbonate, in bicarbonate solution 21).

The herein disclosed system and method provide an effective and economical means for generating hydrogen gas 28 while sequestering captured CO₂ 15′. The low costs of raw materials utilized in this method/process allow it to be much more economical than other well-known hydrogen production processes, including water electrolysis, methane pyrolysis, and steam-methane reforming. In embodiments, most of the raw materials utilized in the process (e.g., alkaline solution, such as NaOH (aq), zero-valent metal particulates 25, water 10′) can be recycled for repeating the reactions (e.g., reaction of Eq. (2A), Eq. (2B), or the like) to generate hydrogen gas 28, thereby reducing costs. In embodiments, by-product (e.g., iron or magnesium) carbonate solids 33 separated in third reactor and/or separation device 20C can be re-utilized or sold for use in other (e.g., cement or steel making) process(es).

In embodiments, the system and method of this disclosure enable capture of CO₂ from hydraulic fracturing operations, for example, via collection of captured CO₂ source 15 from equipment 280 utilized during a hydraulic fracturing operation and separation of impurities 17 therefrom to provide captured CO₂ 15′ for use in the production of hydrogen gas 28 as described herein. Via the system and method of this disclosure, CO₂ can be sequestered long term (via formation of metal carbonate 33 which can, in embodiments, be put to use onsite or at another location (e.g., for cement or steel making process). Sequestration of the captured CO₂ 15′ via this disclosure can provide for a reduction in the emissions of CO₂ to the atmosphere relative to methods in which the CO₂ is not utilized as described herein in a process to produce hydrogen gas 28.

As noted herein, Steam Methane Reforming (SMR) and water electrolysis are the most common processes being utilized to generate most of the available hydrogen in the world today. SMR requires high energy to supply high-temperature steam, while water electrolysis requires large amount of electricity to split the water. Most of these energy sources are derived from burning of fossil fuels. The system and method disclosed herein enable low temperature (e.g., at or near room or ambient temperature) production of hydrogen gas 28 via the use of captured CO₂ 15′. Enabling the production of hydrogen gas 28 to be performed at room or low temperatures, makes the process economically viable because of the cost savings of not paying for the energy required to provide the conventionally needed high temperatures.

The produced hydrogen gas 28 can be utilized as a fuel in one or more hydrogen fuel cells (HFC) 40 to produce electricity 60. The HFC 40 can be used to supply power directly for operating equipment 70 (e.g., frac equipment). The fuel cells 40 can alternatively or additionally be utilized for charging one or more batteries 80.

### Additional Disclosure

The following are non-limiting, specific embodiments in accordance with the present disclosure:

In a first embodiment, a system comprises: a first reactor operable to produce an aqueous bicarbonate solution from captured carbon dioxide (CO₂), and an aqueous alkaline solution; a second reactor fluidly connected with the first reactor and configured to produce hydrogen gas and a mixture comprising metal carbonate agglomerates by contacting the aqueous bicarbonate solution from the first reactor with zero-valent metal particulates, wherein the zero-valent metal particulates comprise a zero-valent metal, and wherein the metal carbonate agglomerates comprise a carbonate of the metal on a surface of the zero-valent metal particulates; and a liquid-solid separator fluidly connected with the second reactor and configured to receive the mixture from the second reactor and separate the metal carbonate agglomerates from a recovered aqueous alkaline solution.

A second embodiment can include the system of the first embodiment, further comprising a third reactor configured to receive at least a portion of the metal carbonate agglomerates separated in the liquid-solid separator, contact the at least the portion of the metal carbonate agglomerates with a weak acid to remove the carbonate of the metal from the metal carbonate agglomerates and thus provide recovered zero-valent metal particulates; and, optionally, a separation device configured to separate the carbonate of the metal from the recovered zero-valent metal particulates.

A third embodiment can include the system of the second embodiment, wherein the weak acid comprises oxalic acid, citric acid, formic acid, acetic acid, benzoic acid, carbonic, trichloroacetic, lactic acid, or a combination thereof.

A fourth embodiment can include the system of any one of the second or third embodiments, further comprising a recovered zero-valent metal particulate recycle line fluidly connecting the third reactor and/or the separation device with the second reactor, whereby the recovered zero-valent metal particulates can be recycled to the second reactor for re-use in the production of the hydrogen gas.

A fifth embodiment can include the system of any one of the second to fourth embodiments, wherein the separation device and the third reactor are a same apparatus.

A sixth embodiment can include the system of the fifth embodiment, wherein the separation device and the third reactor comprise the same apparatus, and wherein the separation device comprises one or more magnets positioned on a wall (e.g., an outside wall) of the third reactor; or wherein the third reactor and the separation device are disparate apparatus, and wherein the separation device comprises the one or more magnets positioned on a wall (e.g., an outside wall) of the separation device.

A seventh embodiment can include the system of any one of the second to sixth embodiments, further comprising storage apparatus connected with the liquid-separator, the third reactor, or both, whereby at least a portion of the metal carbonate aggregates from the liquid-solid separator, at least a portion of the metal carbonate solids from the third reactor, or a combination thereof can be stored in the storage apparatus.

An eighth embodiment can include the system of any one of the first to seventh embodiments, wherein the water of the aqueous alkaline solution comprises fresh water, sea water, produced water, formation water, brine, high-total dissolved solids (TDS) water, or a combination thereof.

A ninth embodiment can include the system of any one of the first to eighth embodiments, wherein the water of the aqueous alkaline solution is from a water source comprising a fresh water source, a brine source, a sea, a formation, a production plant of an oil and gas (O&G) operation, a water processing facility (e.g., a sea water desalination plant, a brackish water desalination plant, a groundwater recovery facility, a wastewater facility, blowdown water from a cooling tower), or a combination thereof.

A tenth embodiment can include the system of any one of the first to ninth embodiments, wherein the captured CO₂ has a purity of greater than or equal to about 99, 99.5, 99.6, 99.7, 99.8, 99.9, or 100 volume percent (vol %).

An eleventh embodiment can include the system of any one of the first to tenth embodiments, wherein the captured CO₂ has been obtained from a CO₂ source comprising a flue gas, an exhaust gas, a produced gas, a landfill gas, the atmosphere, or a combination thereof.

A twelfth embodiment can include the system of the eleventh embodiment, wherein the CO₂ source is produced at a same site at which the system is located (e.g., a wellsite).

A thirteenth embodiment can include the system of any one of the eleventh or twelfth embodiments, further comprising a CO₂ purification apparatus configured for removing one or more impurities (e.g., water, solids (e.g., soot, dust), oxygen, nitrogen, or a combination thereof) from the CO₂ source, such that the captured CO₂ has a purity of greater than or equal to about 99, 99.5, 99.6, 99.7, 99.8, 99.9, or 100 volume percent (vol %).

A fourteenth embodiment can include the system of the thirteenth embodiment, wherein the CO₂ purification apparatus comprises a membrane unit, an amine unit, a carbon fiber filtration unit, or another unit configured to remove the one or more impurities from the captured CO₂.

A fifteenth embodiment can include the system of any one of the eleventh to fourteenth embodiments, wherein the CO₂ source comprises atmosphere (e.g., air), and wherein the system further comprises a CO₂ capture apparatus comprising apparatus for absorbing CO₂ from the air to produce a carbonate solution, and causticize and heat the carbonate solution to release the captured CO₂, wherein the captured CO₂ has a purity of greater than or equal to about 99, 99.5, 99.6, 99.7, 99.8, 99.9, or 100 volume percent (vol %).

A sixteenth embodiment can include the system of any one of the first to fifteenth embodiments, wherein the aqueous alkaline solution comprises sodium hydroxide, potassium hydroxide, lithium hydroxide, rubidium hydroxide, cesium hydroxide, francium hydroxide, or a combination thereof.

A seventeenth embodiment can include the system of any one of the first to sixteenth embodiments, wherein the zero-valent metal comprises magnesium (Mg°) or iron (Fe°).

An eighteenth embodiment can include the system of any one of the first to seventeenth embodiments, wherein the zero-valent metal particulates comprise iron powder or magnesium strips.

A nineteenth embodiment can include the system of any one of the first to eighteenth embodiments, further comprising a recycle line fluidly connecting the liquid-solid separator with the first reactor, whereby the recovered aqueous alkaline solution can be introduced into the first reactor.

A twentieth embodiment can include the system of any one of the first to nineteenth embodiments, wherein the second reactor is configured produce the hydrogen gas and the mixture comprising the metal carbonate agglomerates by contacting the aqueous bicarbonate solution from the first reactor with the zero-valent metal particulates in an anaerobic environment.

A twenty first embodiment can include the system of any one of the first to twentieth embodiments, wherein the first reactor is configured for operation with a pH in a range of from about 7 to about 8.0, from about 7 to about 8.5, from about 7.5 to about 8.0, from about 7.5 to about 8.5, or from about 7.8 to about 8.2.

A twenty second embodiment can include the system of any one of the first to twenty first embodiments, further comprising one or more fuel cells operable to produce electricity from at least a portion of the hydrogen gas produced in the second reactor.

A twenty third embodiment can include the system of the twenty second embodiment, wherein the one or more fuel cells utilize air as a source of oxygen therefor, thus providing an oxygen-depleted air stream comprising primarily nitrogen.

A twenty fourth embodiment can include the system of the twenty third embodiment, wherein the second reactor is configured for introduction thereto of at least a portion of the oxygen-depleted air stream, whereby the at least the portion of the oxygen-depleted air stream can be introduced into the second reactor to provide an anaerobic environment therein (e.g., to purge oxygen from the second reactor prior to introduction of the zero-valent metal particulates thereto).

A twenty fifth embodiment can include the system of any one of the twenty second to twenty fourth embodiments, further comprising one or more pieces of equipment powered at least in part by and/or one or more batteries charged at least in part by the electricity produced in the one or more fuel cells from the at least the portion of the hydrogen gas produced in the second reactor.

A twenty sixth embodiment can include the system of any one of the twenty second to twenty fifth embodiments, wherein the one or more fuel cells are located at a same site (e.g., a wellsite) at which the first reactor, the second reactor, and the liquid-solid separator are located.

A twenty seventh embodiment can include the system of any one of the first to twenty sixth embodiments, further comprising hydrogen storage apparatus configured for storing at least a portion of the hydrogen gas produced in the second reactor.

A twenty eighth embodiment can include the system of the twenty seventh embodiment, wherein the hydrogen storage apparatus is configured for storing the at least the portion of the hydrogen gas produced in the second reactor in a gaseous or liquid state.

A twenty ninth embodiment can include the system of any one of the first to twenty eighth embodiments comprising two first reactors in series.

In a thirtieth embodiment, a method comprises: (i) producing an aqueous bicarbonate solution by contacting captured carbon dioxide (CO₂) with an aqueous alkaline solution; (ii) producing hydrogen gas and a mixture comprising metal carbonate agglomerates by contacting the aqueous bicarbonate solution with zero-valent metal particulates, wherein the zero-valent metal particulates comprise a zero-valent metal, and wherein the metal carbonate agglomerates comprise a carbonate of the metal on a surface of the zero-valent metal particulates; (iii) separating the hydrogen gas from the mixture; and (iv) separating the metal carbonate agglomerates from the mixture to provide a recovered aqueous alkaline solution.

A thirty first embodiment can include the method of the thirtieth embodiment, further comprising (v) contacting at least the portion of the metal carbonate agglomerates with a weak acid to remove the carbonate of the metal from the metal carbonate agglomerates and thus provide recovered zero-valent metal particulates; and (vi) separating the carbonate of the metal from the recovered zero-valent metal particulates.

A thirty second embodiment can include the method of the thirty first embodiment, wherein the weak acid comprises oxalic acid, citric acid, formic acid, acetic acid, benzoic acid, carbonic, trichloroacetic, lactic acid, or a combination thereof.

A thirty third embodiment can include the method of any one of the thirty first or thirty second embodiments, further comprising recycling the recovered zero-valent metal particulates to (ii) for re-use in the producing of the hydrogen gas.

A thirty fourth embodiment can include the method if any one of the thirty first to thirty third embodiments, wherein the contacting of the at least the portion of the metal carbonate agglomerates with the weak acid and the separating of the carbonate of the metal from the recovered zero-valent metal particulates are performed in a same apparatus.

A thirty fifth embodiment can include the method of the thirty fourth embodiment, wherein separating of the carbonate of the metal from the recovered zero-valent metal particulates comprises separating the recovered zero-valent metal particulates from the carbonate of the metal via one or more magnets.

A thirty sixth embodiment can include the method of any one of the thirty first to thirty fifth embodiments, further comprising storing at least a portion of the metal carbonate aggregates separated from the mixture at (iv), at least a portion of the carbonate of the metal separated from the recovered zero-valent metal particles at (vi), or a combination thereof.

A thirty seventh embodiment can include the method of any one of the thirtieth to thirty sixth embodiments, wherein the water of the aqueous alkaline solution comprises fresh water, sea water, produced water, formation water, brine, high-total dissolved solids (TDS) water, or a combination thereof.

A thirty eighth embodiment can include the method of any one of the thirtieth to thirty seventh embodiments, further comprising obtaining the water of the aqueous alkaline solution from a water source comprising a fresh water source, a brine source, a sea, a formation, a production plant of an oil and gas (O&G) operation, a water processing facility (e.g., a sea water desalination plant, a brackish water desalination plant, a groundwater recovery facility, a wastewater facility, blowdown water from a cooling tower), or a combination thereof.

A thirty ninth embodiment can include the method of any one of the thirtieth to thirty eighth embodiments, wherein the captured CO₂ has a purity of greater than or equal to about 99, 99.5, 99.6, 99.7, 99.8, 99.9, or 100 volume percent (vol %).

A fortieth embodiment can include the method of any one of the thirtieth to thirty ninth embodiments, further comprising obtaining the captured CO₂ from a CO₂ source comprising a flue gas, an exhaust gas, a produced gas, a landfill gas, the atmosphere, or a combination thereof.

A forty first embodiment can include the method of any one of the thirtieth to fortieth embodiments, further comprising producing the CO₂ source at a same site at which (i), (ii), (iii), and/or (iv) are performed.

A forty second embodiment can include the method of any one of the fortieth or forty first embodiments, further comprising removing one or more impurities from the CO₂ source to provide the captured CO₂, such that the captured CO₂ has a purity of greater than or equal to about 99, 99.5, 99.6, 99.7, 99.8, 99.9, or 100 volume percent (vol %).

A forty third embodiment can include the method of the forty second embodiment, wherein removing one or more impurities comprises from the CO₂ source comprises passing the CO₂ source through a membrane.

A forty fourth embodiment can include the method of any one of the fortieth to forty third embodiments, wherein the CO₂ source comprises atmosphere (e.g., air), and wherein the method further comprises absorbing CO₂ from the air to produce a carbonate solution, and causticizing and heating the carbonate solution to release the captured CO₂, wherein the captured CO₂ has a purity of greater than or equal to about 99, 99.5, 99.6, 99.7, 99.8, 99.9, or 100 volume percent (vol %).

A forty fifth embodiment can include the method of any one of the thirtieth to forty fourth embodiments, wherein the aqueous alkaline solution comprises water and sodium hydroxide, potassium hydroxide, lithium hydroxide, rubidium hydroxide, cesium hydroxide, francium hydroxide, or a combination thereof.

A forty sixth embodiment can include the method of any one of the thirtieth to forty fifth embodiments, wherein the zero-valent metal comprises magnesium (Mg°) or iron (Fe°).

A forty seventh embodiment can include the method of any one of the thirtieth to forty sixth embodiments, wherein the zero-valent metal particulates comprise iron powder or magnesium strips.

A forty eighth embodiment can include the method of any one of the thirtieth to forty seventh embodiments, further comprising recycling the recovered aqueous alkaline solution to (i).

A forty ninth embodiment can include the method of any one of the thirtieth to forty eighth embodiments, wherein (ii) comprises contacting the aqueous bicarbonate solution with the zero-valent metal particulates in an anaerobic environment.

A fiftieth embodiment can include the method of any one of the thirtieth to forty ninth embodiments, further comprising maintaining a pH in a range of from about 7 to about 8.0, from about 7 to about 8.5, from about 7.5 to about 8.0, from about 7.5 to about 8.5, or from about 7.8 to about 8.2 at (i) via the aqueous alkaline solution.

A fifty first embodiment can include the method of any one of the thirtieth to fiftieth embodiments, further comprising producing electricity (e.g., via or more fuel cells) from at least a portion of the hydrogen gas produced at (ii).

A fifty second embodiment can include the method of the fifty first embodiment, further comprising utilizing air as a source of oxygen for one or more fuel cells configured to produce the electricity from the at least the portion of the hydrogen gas produced at (ii), and so producing an oxygen-depleted air stream comprising primarily nitrogen.

A fifty third embodiment can include the method of the fifty second embodiment, further comprising utilizing at least a portion of the oxygen-depleted air stream at (ii), to provide an anaerobic environment for the contacting of the aqueous bicarbonate solution with the zero-valent metal particulates.

A fifty fourth embodiment can include the method of any one of the fifty first to fifty third embodiments, further comprising powering one or more pieces of equipment at least in part by and/or charging one or more batteries at least in part by the electricity produced from at least a portion of the hydrogen gas produced at (ii).

A fifty fifth embodiment can include the method of any one of the fifty first to fifty fourth embodiments, wherein producing the electricity (e.g., via or more fuel cells) from the at least the portion of the hydrogen gas produced at (ii) is performed a same site (e.g., a wellsite) at which (i), (ii), (iii), and/or (iv) are performed.

A fifty sixth embodiment can include the method of any one of the thirtieth to fifty fifth embodiments, further comprising storing at least a portion of the hydrogen gas produced at (ii).

A fifty seventh embodiment can include the method of the fifty sixth embodiment, wherein the at least the portion of the hydrogen gas produced at (ii) that is stored is stored in a gaseous or liquid state.

In a fifty eighth embodiment, a method comprises: producing hydrogen gas and a mixture comprising metal carbonate agglomerates by contacting an aqueous bicarbonate solution with zero-valent metal particulates, wherein the zero-valent metal particulates comprise a zero-valent metal, wherein the metal carbonate agglomerates comprise a carbonate of the metal on a surface of the zero-valent metal particulates, wherein the aqueous bicarbonate solution comprises water and a bicarbonate, and wherein the bicarbonate comprises carbon from captured carbon dioxide (CO₂) captured from a flue gas, an exhaust gas (e.g., from fracturing equipment (e.g., hydraulic fracturing pumping equipment, hydraulic horsepower pumping units, electrical generation natural gas turbine units, electrical generation reciprocating natural gas power units or a combination thereof)), a produced gas, a landfills gas, air, or a combination thereof.

A fifty ninth embodiment can include the method of the fifty eighth embodiment, further comprising utilizing at least a portion of the hydrogen gas to produce electricity.

A sixtieth embodiment can include the method of the fifty ninth embodiment, wherein the captured CO₂ is produced at a same site at which the method is performed, the water in the aqueous bicarbonate solution is produced or obtained at the same site at which the method is performed, the electricity produced from the at least the portion of the hydrogen gas is produced and/or utilized at the same site at which the method is performed, or a combination thereof.

A sixty first embodiment can include the method of any one of the fifty eighth to sixtieth embodiments, wherein the captured CO₂ is produced at a same site at which the method is performed, the water in the aqueous bicarbonate solution is produced or obtained at the same site at which the method is performed, or a combination thereof.

A sixty second embodiment can include the method of any one of the fifty eighth to sixty first embodiments, wherein the water of the aqueous bicarbonate solution comprises fresh water, sea water, produced water, formation water, brine, high-total dissolved solids (TDS) water, or a combination thereof.

A sixty third embodiment can include the method of any one of the fifty eighth to sixty second embodiments, wherein the water is from a water source comprising a fresh water source, a brine source, a sea, a formation, a production plant of an oil and gas (O&G) operation, a water processing facility (e.g., a sea water desalination plant, a brackish water desalination plant, a groundwater recovery facility, a wastewater facility, blowdown water from a cooling tower), or a combination thereof.

A sixty fourth embodiment can include the method of the sixty third embodiment, wherein the producing of the hydrogen gas is performed substantially continuously or intermittently.

While embodiments have been shown and described, modifications thereof can be made by one skilled in the art without departing from the spirit and teachings of this disclosure. The embodiments described herein are exemplary only, and are not intended to be limiting. Many variations and modifications of the embodiments disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, RI, and an upper limit, Ru, is disclosed, any number falling within the range is specifically disclosed. In particular, the following numbers within the range are specifically disclosed: R=RI+k*(Ru−RI), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

What is claimed is:

1. A system comprising:
a first reactor operable to produce an aqueous bicarbonate solution from captured carbon dioxide (CO₂) and an aqueous alkaline solution;
a second reactor fluidly connected with the first reactor and configured to produce hydrogen gas and a mixture comprising metal carbonate agglomerates by contacting the aqueous bicarbonate solution from the first reactor with zero-valent metal particulates, wherein the zero-valent metal particulates comprise a zero-valent metal, and wherein the metal carbonate agglomerates comprise a carbonate of the metal on a surface of the zero-valent metal particulates; and
a liquid-solid separator fluidly connected with the second reactor and configured to receive the mixture from the second reactor and separate the metal carbonate agglomerates from a recovered aqueous alkaline solution.

2. The system of claim 1 further comprising a third reactor configured to receive at least a portion of the metal carbonate agglomerates separated in the liquid-solid separator, contact the at least the portion of the metal carbonate agglomerates with a weak acid to remove the carbonate of the metal from the metal carbonate agglomerates and thus provide recovered zero-valent metal particulates; and, optionally, a separation device configured to separate the carbonate of the metal from the recovered zero-valent metal particulates.

3. The system of claim 2 further comprising a recovered zero-valent metal particulate recycle line fluidly connecting the third reactor and/or the separation device with the second reactor, whereby the recovered zero-valent metal particulates can be recycled to the second reactor for re-use in the production of the hydrogen gas.

4. The system of claim 2, wherein the separation device and the third reactor are a same apparatus.

5. The system of claim 1 further comprising a recycle line fluidly connecting the liquid-solid separator with the first reactor, whereby the recovered aqueous alkaline solution can be introduced into the first reactor.

6. The system of claim 1, wherein the second reactor is configured produce the hydrogen gas and the mixture comprising the metal carbonate agglomerates by contacting the aqueous bicarbonate solution from the first reactor with the zero-valent metal particulates in an anaerobic environment.

7. The system of claim 1 further comprising one or more fuel cells operable to produce electricity from at least a portion of the hydrogen gas produced in the second reactor.

8. The system of claim 7 further comprising one or more pieces of equipment powered at least in part by the electricity and/or one or more batteries charged at least in part by the electricity.

9. A method comprising:
(i) producing an aqueous bicarbonate solution by contacting captured carbon dioxide (CO₂) with an aqueous alkaline solution;
(ii) producing hydrogen gas and a mixture comprising metal carbonate agglomerates by contacting the aqueous bicarbonate solution with zero-valent metal particulates, wherein the zero-valent metal particulates comprise a zero-valent metal, and wherein the metal carbonate agglomerates comprise a carbonate of the metal on a surface of the zero-valent metal particulates;
(iii) separating the hydrogen gas from the mixture; and
(iv) separating the metal carbonate agglomerates from the mixture to provide a recovered aqueous alkaline solution.

10. The method of claim 9 further comprising (v) contacting at least a portion of the metal carbonate agglomerates with a weak acid to remove the carbonate of the metal from the metal carbonate agglomerates and thus provide recovered zero-valent metal particulates; and (vi) separating the carbonate of the metal from the recovered zero-valent metal particulates.

11. The method of claim 10 further comprising recycling the recovered zero-valent metal particulates to (ii) for re-use in the producing of the hydrogen gas.

12. The method of claim 9, further comprising producing the CO₂ source at a same site at which (i), (ii), (iii), and/or (iv) are performed.

13. The method of claim 9 further comprising recycling the recovered aqueous alkaline solution to (i).

14. The method of claim 9 further comprising producing electricity from at least a portion of the hydrogen gas produced at (ii).

15. The method of claim 14 further comprising powering one or more pieces of equipment at least in part by the electricity and/or charging one or more batteries at least in part by the electricity.

16. The method of claim 14, wherein producing the electricity from the at least the portion of the hydrogen gas produced at (ii) is performed a same site at which (i), (ii), (iii), and/or (iv) are performed.

17. A method comprising:
producing hydrogen gas and a mixture comprising metal carbonate agglomerates by contacting an aqueous bicarbonate solution with zero-valent metal particulates, wherein the zero-valent metal particulates comprise a zero-valent metal, wherein the metal carbonate agglomerates comprise a carbonate of the metal on a surface of the zero-valent metal particulates, wherein the aqueous bicarbonate solution comprises water and a bicarbonate, and wherein the bicarbonate comprises carbon from captured carbon dioxide (CO₂) captured from a flue gas, an exhaust gas, a produced gas, a landfills gas, air, or a combination thereof.

18. The method of claim 17 further comprising utilizing at least a portion of the hydrogen gas to produce electricity.

19. The method of claim 18, wherein the captured CO₂ is produced at a same site at which the method is performed, the water in the aqueous bicarbonate solution is produced or obtained at the same site at which the method is performed, the electricity produced from the at least the portion of the hydrogen gas is produced and/or utilized at the same site at which the method is performed, or a combination thereof.

20. The method of claim 17, wherein the captured CO₂ is produced at a same site at which the method is performed, the water in the aqueous bicarbonate solution is produced or obtained at the same site at which the method is performed, the producing of the hydrogen gas is performed substantially continuously or intermittently, or a combination thereof.
